(19) United States
(12) Patent Application Publication
(10) Pub. No.: US 2010/0275660 A1
(43) Pub. Date: Nov. 4, 2010

(54) Motor, method of manufacturing the same, and washing machine having motor manufactured thereby

(75) Inventors: Keun Young Yoon, Hwaseong-si (KR); Young Kwan Kim, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/662,285

(22) Filed: Apr. 8, 2010

(30) Foreign Application Priority Data
Apr. 30, 2009 (KR) 10-2009-38200

(51) Int. Cl. H02K 1/14; H02K 3/34; H02K 15/02; D06F 37/30

(52) U.S. Cl. 68/212; 310/216.079; 310/216.009; 310/215; 29/596

(57) ABSTRACT

Disclosed are a motor including a stator and a rotor separated from each other in an axial direction and a washing machine having the motor. Teeth made of a member formed separately from bobbins formed on the stator are installed on the bobbins. Therefore, the teeth are installed on the bobbins after a wire is wound on the bobbins.

### CROSS-REFERENCE TO RELATED APPLICATIONS

This application claims the benefit of Korean Patent Application No. 2009-0038200, filed on Apr. 30, 2009 in the Korean Intellectual Property Office, the disclosure of which is incorporated herein by reference.

### BACKGROUND

1. Field

Embodiments of the present invention relate to a motor to generate rotary force, a method of manufacturing the same, and a washing machine having a motor manufactured thereby.

2. Description of the Related Art

In general, a motor includes a stator, a rotor rotatably installed at the outside of the stator and rotated while interacting with the stator, and a rotary shaft provided with one end installed at the rotor and rotated together with the rotor. If the motor is applied to a washing machine, the other end of the rotary shaft is installed at a drum of the washing machine and used to rotate the drum.

In such a motor, the stator is formed in a ring shape and includes a plurality of bobbins, on which a wire is wound to form coils. Teeth parts are respectively formed integrally with the front ends of the bobbins to cause a magnetic field generated from the coils to more easily interact with a magnetic field generated from magnets of the rotor.

Since the wire is wound on the bobbins through narrow spaces between the teeth parts during a process of forming the coils by winding the wire on the bobbins, winding of the wire is difficult. Particularly, if the motor has narrow intervals between the teeth parts, such a problem is more severe.

In a washing machine, to which such a motor is applied, in order to increase output of the motor to improve the performance of the washing machine, the thickness of the motor must be increased. In order to increase the thickness of the motor within a housing having a designated size, the sizes of a tub and a drum must be reduced to secure a space to install the motor. In this case, the capacity of the washing machine is reduced, and thus increase in output of the motor is limited.

### SUMMARY

Therefore, it is one aspect of the present invention to provide a motor, on which a wire is more easily wound.

It is another aspect of the present invention to provide a washing machine using a motor, which has higher output without decrease in capacity of the washing machine.

Additional aspects of the invention will be set forth in part in the description which follows and, in part, will be apparent from the description, or may be learned by practice of the invention.

The foregoing and/or other aspects of the present invention may be achieved by providing a motor including a stator and a rotor separate from the stator in an axial direction of the motor, wherein the stator includes a stator core formed in a ring shape, the stator core having a plurality of bobbins protruding toward the rotor, and teeth respectively formed at front ends of the bobbins.

The stator core may include a plurality of split cores connected in a circumferential direction to form the stator core, and bobbin parts to form the bobbins may be respectively formed at both ends of the split cores and the bobbin parts of the neighboring split cores may form each of the bobbins.

The split cores may be respectively formed by stacking a plurality of core plates, and the bobbin parts may be formed by respectively bending both ends of the stacked core plates.

A bending groove to facilitate the bending of the split cores may be formed at each of both sides of the central portions of the split cores.

The teeth may be respectively formed by stacking a plurality of teeth plates, and the teeth plates of the teeth may be arranged in parallel with the core plates forming the bobbin parts.

An installation depression, in which the front end of each of the bobbins is installed, may be formed on each of the teeth.

The motor may further include a stator plate formed in a ring shape, to which the split cores are fixed in a circumferential direction.

The rotor may include a plurality of magnets arranged opposite the teeth, and a rotor plate provided with the edge, to which the magnets are fixed in a circumferential direction.

The motor may further include insulating members made of an insulating material, and respectively installed on the bobbins such that the insulating members are respectively interposed between the bobbins and the coils.

The foregoing and/or other aspects of the present invention may also be achieved by providing a washing machine including a tub, a drum rotatably installed in the tub, and a motor to rotate the drum, wherein the motor includes a stator, a rotor, and a rotary shaft provided with one end installed at the drum and another end installed at the rotor, and the stator and the rotor are separated from each other in an axial direction of the rotary shaft.

The foregoing and/or aspects of the present invention may also be achieved by providing a method of manufacturing a motor, the method including preparing a plurality of split cores and a plurality of teeth, forming a stator core comprising arranging the plurality of split cores in a circumferential direction, installing insulating members on bobbins formed on the stator core, forming coils comprising winding a wire on the insulating members, and fixing the teeth to the front ends of the bobbins.

The respective preparation of the plurality of split cores may include stacking a plurality of core plates, forming bobbin parts by bending both ends of the stacked core plates, and bending the stacked core plates in a circumferential direction centering on one side of both sides of the central portions of the stacked core plates.

The respective preparation of the plurality of teeth may include stacking a plurality of teeth plates.

The plurality of teeth may be installed on the bobbins such that the plurality of teeth plates forming each of the plurality of teeth is arranged in parallel with a radial direction of the stator core.

The formation of the stator core by arranging the plurality of split cores in the circumferential direction may be achieved by fixing the plurality of split cores to a stator plate formed in a ring shape.

The formation of the coils by winding the wire on the insulating members may be carried out after the installation of the insulating members on the bobbins formed on the stator core.

Further, the installation of the insulating members on the bobbins formed on the stator core may be carried out after the formation of the coils by winding the wire on the insulating members.

### BRIEF DESCRIPTION OF THE DRAWINGS

These and/or other aspects of the invention will become apparent and more readily appreciated from the following description of the embodiments, taken in conjunction with the accompanying drawings in which:

FIG. 1 is a longitudinal-sectional view illustrating the schematic configuration of a washing machine, to which a motor in accordance with one embodiment of the present invention is applied;

FIG. 2 is an exploded perspective view of the motor in accordance with the embodiment of the present invention;

FIG. 3 is a partially exploded perspective view of a stator applied to the motor in accordance with the embodiment of the present invention;

FIGS. 4 to 10 are perspective views illustrating a manufacturing process of the stator applied to the motor in accordance with the embodiment of the present invention; and

FIG. 11 is a perspective view illustrating an intermediate manufacturing process of the stator applied to a motor in accordance with another embodiment of the present invention.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Hereinafter, a motor and a washing machine having the same in accordance with one embodiment of the present invention will be described with reference to the accompanying drawings.

In this embodiment, a drum washing machine among various kinds of washing machines is exemplarily described.

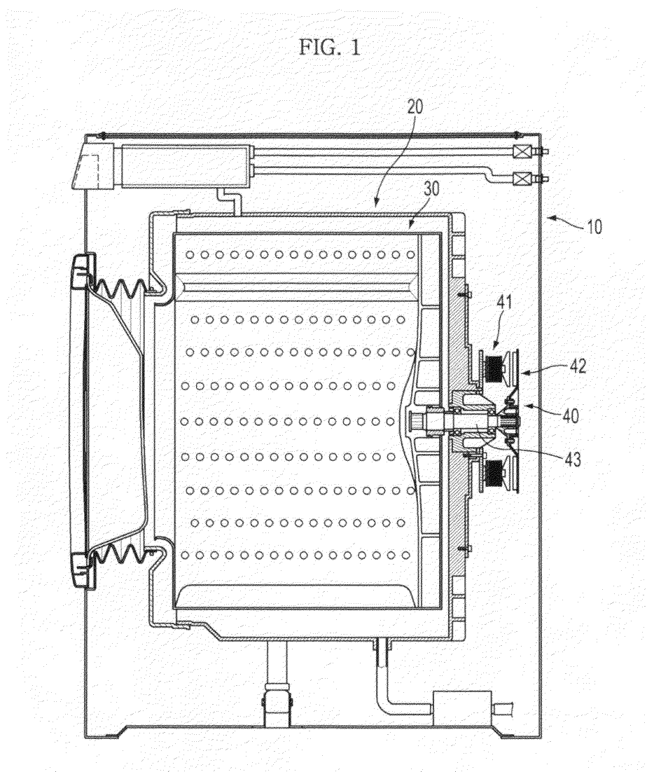

As shown in FIG. 1, the washing machine, to which the motor in accordance with this embodiment is applied, includes a housing 10 forming the external appearance of the washing machine, a tub 20 disposed in the housing 10 to contain water, a drum 30 rotatably installed in the tub 20, and a motor 40 generating rotary force to rotate the drum 30.

The motor 40 includes a stator 41 fixed to the tub 20, a rotor 42 rotated while interacting with the stator 41, and a rotary shaft 43 provided with one end installed at the rotor 42 and the other end passing through the tub 20 and installed at the drum 30 and thus rotated together with the rotor 42 to rotate the drum 30.

In this embodiment, the motor 40 is an axial gap-type motor, in which the stator 41 and the rotor 42 are separated from each other in the axial direction of the rotary shaft 43. Since the axial gap-type motor has a relatively thin thickness in the axial direction as compared with general motors, the motor 40 having a large output may be applied to the housing 10 having a regular size. Further, if the axial gap-type motor uses magnets having a large size to increase the output, the diameter of the motor 40 needs to be increased but the thickness of the motor 40 may be uniformly maintained, and thus the motor 40 having a large output may be applied to the washing machine.

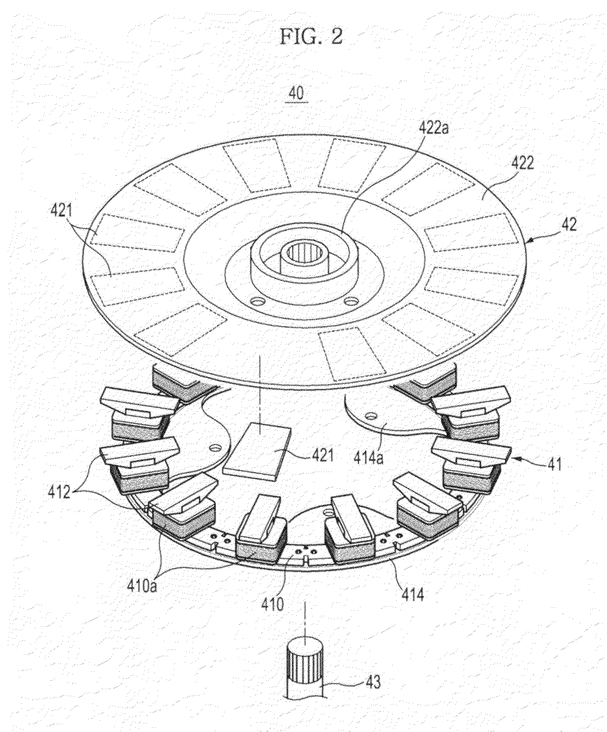

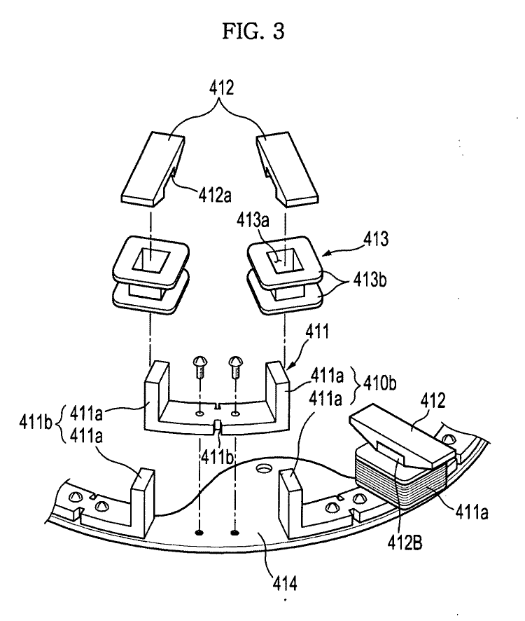

As shown in FIGS. 2 and 3, the stator 41 includes a stator core 410 formed in a ring shape and including bobbins 410b protruded toward the rotor 42 such that a wire is wound on the bobbins 410b to form coils 410a, teeth 412 made of a member formed separately from the stator core 410 and fixed to the front ends of the bobbins 410b, insulating members 413 installed on the bobbins 410b and interposed between the coils 410b and the bobbins 410b, and insulating members 413 to insulate the coils 410a and the bobbins 410b from each other.

The insulating members 413 are made of an insulating material, such as resin, and exhibit several functions, such as insulation between the bobbins 410b and the coils 410a, prevention of breakdown of a film on the surface of the wire due to friction with corners of the bobbins 410a during a process of winding the wire, and formation of the uniform shape of the coils 410a. Each of the insulating members 413 is provided with a through hole 413a formed in a shape corresponding to the bobbin 410b such that the bobbin 410b is inserted into the through hole 413a, and supporting ribs 413b respectively extended from both ends of each of the insulating members 413 to facilitate the formation of the coil 410a and allow the coil 410a to be formed in a uniform shape.

The plural bobbins 410b are formed on the stator core 410 such that the bobbins 410b are separated from each other in the circumferential direction, and the wire is wound on the bobbins 410b. The teeth 412 are respectively fixed to the front ends of the bobbins 410b by welding or bonding. If the teeth 412 are manufactured separately from the stator core 410, the teeth 412 are fixed to the bobbins 410b after the wire is wound on the bobbins 410b. Therefore, the winding of the wire on the bobbins 410b is easily achieved without the influence of the teeth 412.

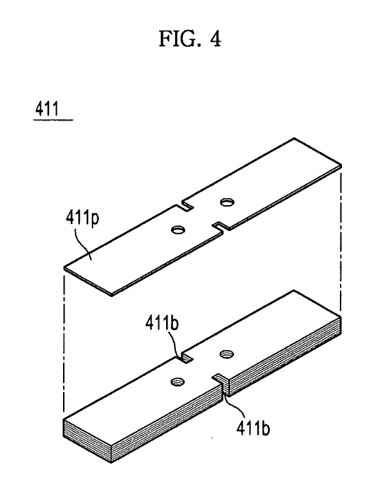

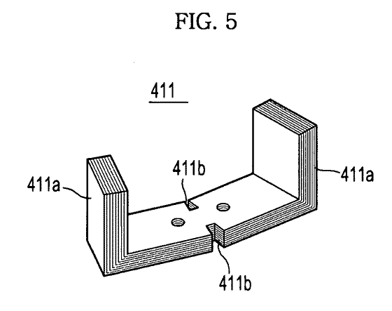

The stator core 410 is formed in a ring shape by connecting a plurality of split cores 411 in the circumferential direction. Each of the split cores 411 is manufactured by stacking a plurality of plate-shaped core plates 411p having a regular length, as shown in FIG. 4, forming bobbin parts 411a by respectively bending both ends of the stacked core plates 411p perpendicularly, as shown in FIG. 5, and bending the stacked core plates 411p in the circumferential direction centering on one side of both sides of the central portions of the stacked core plates 411p. Here, bending grooves 411b to facilitate the bending of the split core 411 are formed at both sides of the central portion of the split core 411. Therefore, when the split cores 411 provided with the bobbin parts 411a at both ends thereof are arranged in the circumferential direction, the neighboring two bobbin parts 411a of the neighboring two split cores 411 form the above-described bobbin 410b.

In order to arrange the plural split cores 411 in the circumferential direction, as described above, a stator plate 414 formed in a ring shape, on which the plural split cores 411 are fixed in the circumferential direction, is provided as shown in FIG. 3. Further, fixing parts 414a to fix the stator 41 to the tub 20 are extended from the inner circumferential end of the stator plate 414, and the stator 41 is fixed to the tub 20 by connecting the fixing parts 414a of the stator 41 to the rear surface of the tub 20 by bolts.

The teeth 412 are extended in the radial direction of the stator 41 to easily interact with the rotor 42. The bottom surface of each of the teeth 412 opposite each of magnets 421 of the rotor 42 has a trapezoidal shape, and an insertion recess 412a, into which the front end of each of the bobbins 410b is inserted, is formed on the upper surface of each of the teeth 412 so that the front end of each of the bobbins 410b is fixed into the insertion recess 412a of each of the teeth 412 by welding or bonding.

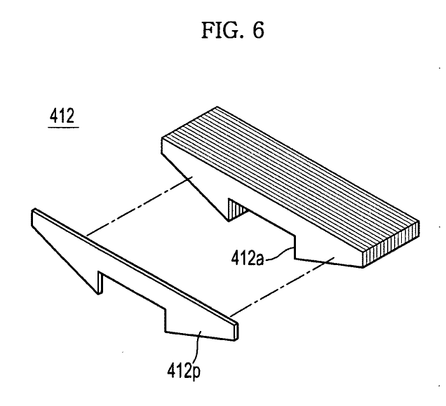

Further, each of the teeth 412 is formed by stacking a plurality of teeth plates 412p, as shown in FIG. 6, and is installed on each of the bobbins 410b such that the teeth plates 412p forming each of the teeth 412 are disposed in parallel with the radial direction of the stator 41. When the teeth plates 412p are installed in this way, the teeth plates 412p are disposed in parallel with the core plates 411p at the bobbin parts 411a of the split cores 411, thus being capable of minimizing loss of a magnetic field generated while the magnetic field passes through gaps between the bobbins 410b and the teeth 412.

With reference to FIG. 2, the rotor 42 includes a plurality of permanent magnets 421 disposed opposite the teeth 412 of the rotor 41, and a rotor plate 422 provided with a hub part 422a at the center thereof, where the rotary shaft 43 is installed, to fix the plural magnets 421 in the circumferential direction along the edge thereof.

Hereinafter, a method of manufacturing the above motor in accordance with the embodiment of the present invention will be described.

First, the plural split cores 411 and the plural teeth 412 are respectively prepared. Each of the split cores 411 is prepared by stacking the plural core plates 411p, as shown in FIG. 4, forming the bobbin parts 411a by respectively bending both ends of the stacked core plates 411p, as shown in FIG. 5, and bending the stacked core plates 411p in the circumferential direction centering on one side of both sides of the central portions of the stacked core plates 411p. Each of the teeth 412 is prepared by stacking the plural teeth plates 412p, as shown in FIG. 6.

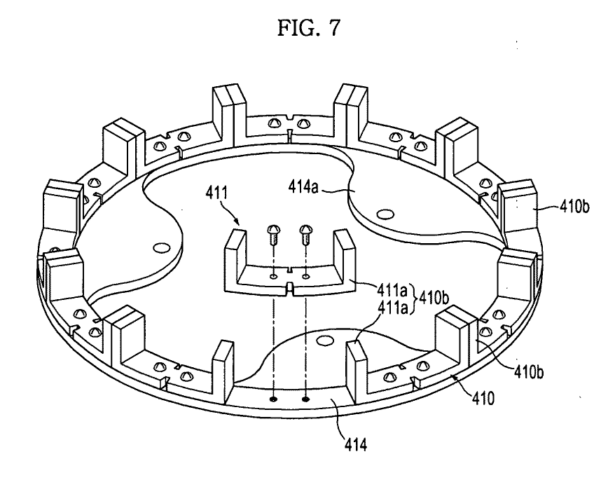

The stator core 410 is formed by arranging the plural split cores 411 prepared by the above process in the circumferential direction, as shown in FIG. 7. The above process of forming the stator core 410 is implemented by fixing the plural split cores 411 onto the stator plate 414 in the circumferential direction using screws. The bobbin parts 411a of the respective split cores 411 contact the bobbin parts 411a of the neighboring split cores 411, and the two bobbin parts 411a, contacting each other, form a single bobbin 410b.

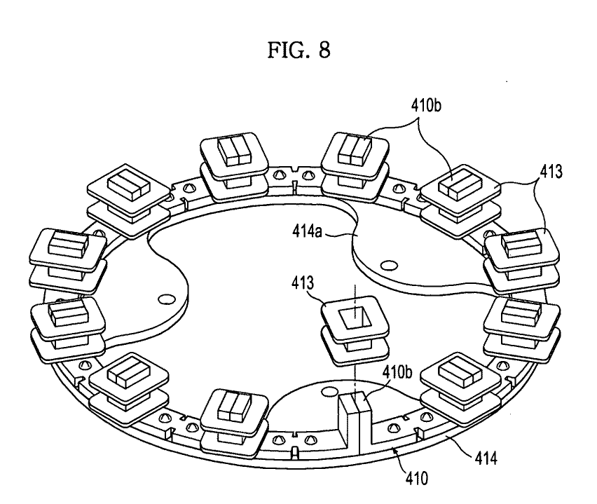

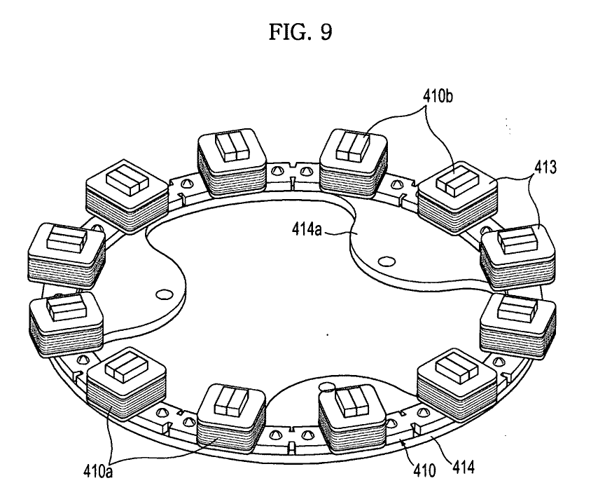

After the formation of the stator core 410 is completed, the insulating members 413 are installed on the bobbins 410b via the through holes 413a, as shown in FIG. 8, and the coils 410a are formed on the bobbins 410b covered with the insulating members 413 by winding the wire on the insulating members 413, as shown in FIG. 9. Here, since the bobbins 410b are separated from each other by sufficient intervals, an operation of forming the coils 410a by winding the wire on the insulating members 413 is easily achieved.

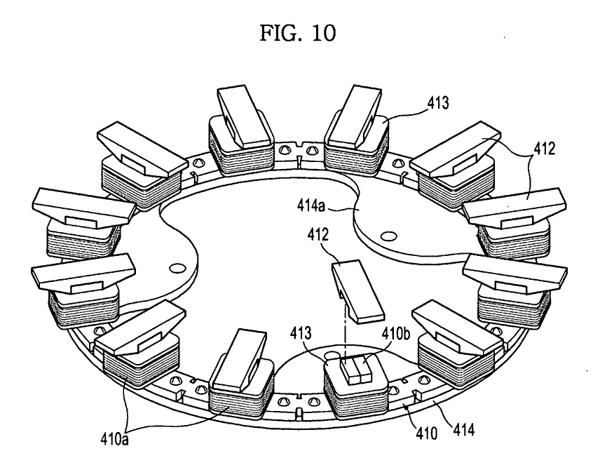

After the formation of the coils 410a is completed, the front ends of the bobbins 410b are inserted into the installation depressions 412a of the teeth 412, and then are fixed to the installation depressions 412a of the teeth 412 by partial welding or bonding, as shown in FIG. 10, thereby completing the manufacture of the stator 41 of the motor 40. Here, the respective teeth 412 are fixed to the motor 40 such that the teeth plates 412p of the teeth 412 are substantially parallel with the radial direction of the stator core 410.

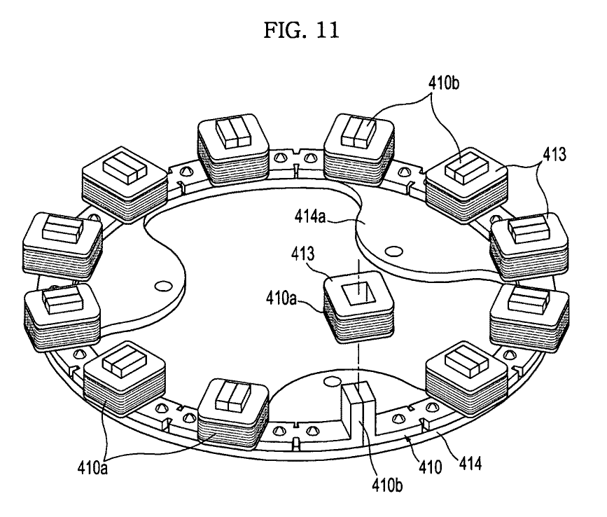

This embodiment describes that the coils 410a are formed by winding the wire on the insulating members 413 after the insulating members 413 are installed on the bobbins 410b. However, as shown in FIG. 11, after the coils 410a are formed by winding the wire on the insulating members 413, the insulating members 413 provided with the coils 410a may be installed on the bobbins 410b.

Although this embodiment describes that the motor is applied to a drum washing machine, the motor may be applied to a pulsator washing machine.

Further, although this embodiment describes that the motor is applied to a washing machine, the motor may be applied to other various apparatuses using an axial gap-type motor.

As is apparent from the above description, a motor in accordance with one aspect of the present invention includes teeth made of a member formed separately from bobbins, and allows the teeth to be fixed to the front ends of the bobbins after a wire is wound on the bobbins, thereby simplifying an operation of winding the wire on the bobbins.

Further, a washing machine in accordance with another aspect of the present invention uses an axial gap-type motor having a relatively thin thickness, in which a stator and a rotor are disposed in the axial direction, compared with a general motor, thereby being capable of employing a motor having a higher output without decrease in capacities of a tub and a drum.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. A motor, comprising:
a stator; and
a rotor separate from the stator in an axial direction of the motor,
wherein the stator includes a stator core formed in a ring shape, the stator core having a plurality of bobbins protruding toward the rotor, and teeth respectively formed at front ends of the bobbins.

2. The motor according to claim 1, wherein:
the stator core includes a plurality of spilt cores connected in a circumferential direction to form the stator core; and
a plurality of bobbin parts to form the bobbins, respectively formed at ends of the split cores, the bobbin parts of the neighboring split cores forming each of the bobbins.

3. The motor according to claim 1, wherein:
the split cores each comprise a plurality of stacked core plates; and
the bobbin parts are formed by respectively bending ends of the stacked core plates.

4. The motor according to claim 3, wherein a bending groove to facilitate the bending of the split cores is formed at each of the sides of central portions of the split cores.

5. The motor according to claim 2, wherein:
the teeth each comprise a plurality of stacked teeth plates; and
the teeth plates of the teeth are arranged in parallel with the core plates.

6. The motor according to claim 1, wherein an installation depression, in which the front end of each of the bobbins is installed, is formed on each of the teeth.

7. The motor according to claim 1, further comprising a stator plate formed in a ring shape, to which the split cores are fixed in a circumferential direction.

8. The motor according to claim 1, wherein the rotor includes a plurality of magnets arranged opposite the teeth, and a rotor plate provided with the edge, to which the magnets are fixed in a circumferential direction.

9. The motor according to claim 1, further comprising a plurality of insulating members made of an insulating material, and respectively installed on the bobbins such that the insulating members are respectively interposed between the bobbins and the coils.

10. A washing machine comprising:
a tub;
a drum rotatably installed in the tub; and
a motor to rotate the drum, wherein:
the motor includes a stator, a rotor, and a rotary shaft provided with one end installed at the drum and another end installed at the rotor; and
the stator and the rotor are separated from each other in an axial direction of the rotary shaft.

11. The washing machine according to claim 10, wherein the stator includes a stator core formed in a ring shape and comprising bobbins protruded toward the rotor to form coils, and teeth formed at front ends of the bobbins.

12. The washing machine according to claim 11, wherein:
the stator core includes a plurality of spilt cores connected in a circumferential direction to form the stator core; and
bobbin parts are respectively formed at ends of the split cores, and the bobbin parts of the neighboring split cores form each of the bobbins.

13. The washing machine according to claim 12, wherein:
the split cores respectively comprise a plurality of stacked core plates; and
the bobbin parts are formed by respectively bending both ends of the stacked core plates.

14. The washing machine according to claim 13, wherein a bending groove to facilitate the bending of the split cores is formed at each of both sides of the central portions of the split cores.

15. The washing machine according to claim 13, wherein:
the teeth are respectively formed by stacking a plurality of teeth plates; and
the teeth plates are arranged in parallel with the core plates, thereby forming the bobbin parts.

16. A method of manufacturing a motor comprising:
preparing a plurality of split cores and a plurality of teeth;
forming a stator core comprising arranging the plurality of split cores in a circumferential direction;
installing insulating members on bobbins formed on the stator core;
forming coils comprising winding a wire on the insulating members; and
fixing the teeth to the front ends of the bobbins.

17. The method according to claim 16, wherein the preparing of the plurality of split cores includes:
stacking a plurality of core plates;
forming bobbin parts comprising bending both ends of the stacked core plates; and
bending the stacked core plates in a circumferential direction centering on one side of both sides of the central portions of the stacked core plates.

18. The method according to claim 16, wherein the respective preparation of the plurality of teeth includes stacking a plurality of teeth plates.

19. The method according to claim 18, wherein the plurality of teeth is installed on the bobbins such that the plurality of teeth plates forming each of the plurality of teeth is arranged in parallel with a radial direction of the stator core.

20. The method according to claim 16, wherein the forming of the stator core comprises fixing the plurality of split cores to a stator plate formed in a ring shape.

21. The method according to claim 16, wherein the forming the coils is carried out after the installing the insulating members.

22. The method according to claim 16, wherein the installing of the insulating members on the bobbins formed on the stator core is carried out after the forming of the coils.
